(19) United States
(12) Patent Application Publication
(10) Pub. No.: US 2025/0308486 A1
(43) Pub. Date: Oct. 2, 2025

(54) KEYBOARD DEVICE FOR KEYBOARD INSTRUMENT

(71) Applicant: KABUSHIKI KAISHA KAWAI GAKKI SEISAKUSHO, Hamamatsu-shi (JP)

(72) Inventors: Anne ISHIDA, Hamamatsu-shi (JP); Masahiko IWASE, Hamamatsu-shi (JP)

(21) Appl. No.: 19/084,408

(22) Filed: Mar. 19, 2025

(30) Foreign Application Priority Data
Mar. 26, 2024 (JP) 2024-049392

(51) Int. Cl. G10C 3/18; G10H 1/34

(52) U.S. Cl. CPC G10C 3/18; G10H 1/346

(57) ABSTRACT

A keyboard device for a keyboard instrument includes: a swingable key; an action unit executing a predetermined operation in conjunction with depression of the key; and a hammer placed on the action unit via a hammer protruding portion, and rotated upward via the action unit in accordance with depression of the key. The hammer includes a hammer body made of a synthetic resin, and the hammer protruding portion includes a protruding portion body protruding downward and formed integrally with the hammer body, and a roller bush attached to the hammer body in a state of covering the protruding portion body.

### CROSS-REFERENCE TO RELATED APPLICATION

This application claims priority to Japanese Patent Application Number 2024-049392, filed on Mar. 26, 2024, the entire content of which is incorporated herein by reference.

### BACKGROUND

### Technical Field

The present invention relates to a keyboard device for a keyboard instrument, and more particularly to a keyboard device for a keyboard instrument including an action unit that operates in conjunction with key depression, and a hammer placed on the action unit and driven upward via the action unit in accordance with the key depression.

### Related Art

In general, a grand piano that is an acoustic piano is provided with an action that operates in accordance with key depression and causes a hammer to rotate upward to perform string striking. An example of such an action is disclosed in, for example, JP 2003-167572 A already filed by the present applicant. This action is provided for each key, and includes a wippen that is rotatably supported and placed on a rear portion of the key, a repetition lever and a jack that are rotatably attached to the wippen, a repetition spring that biases them in a predetermined direction, a repetition screw and a regulating button that regulate the rotation of the repetition lever and the jack, respectively, and the like.

The hammer includes a hammer shank that extends in a front-rear direction and has a shank roller attached to a proximal end portion side, a hammer head that is attached to a distal end portion thereof, and the like. The hammer is rotatably supported at the proximal end portion of the hammer shank.

In the above action, the repetition lever is provided with a jack guide hole penetrating the repetition lever in an up-down direction, and the hammer is placed near the jack guide hole via the shank roller. In addition, the jack is formed in an L-shaped side surface shape, and a distal end portion of a hammer push-up portion extending in the up-down direction is inserted into the jack guide hole of the repetition lever from below, engaged movably in the front-rear direction, and faces the shank roller.

In the grand piano including the hammer and the action configured as described above, when the key is depressed, the wippen pushed up at the rear portion of the key rotates upward, and accordingly, the repetition lever and the jack also move upward. Along with this, first, the repetition lever pushes up the hammer via the shank roller while sliding the shank roller, and rotates the hammer upward. Then, the repetition lever is locked by abutting on the repetition screw, so that the jack pushes up the hammer via the shank roller. Then, when the hammer rotates to just before striking the upwardly tensioned string, the jack comes out of the shank roller by engaging the regulating button (disengagement). By such disengagement of the jack, the hammer is uncoupled from the action and the key, and strikes the string in a free rotation state. Note that, when the jack disengages, a change in the touch weight (static load) of the key, specifically, a click feeling due to a rapid increase in the touch weight and a rapid decrease immediately after the rapid increase occurs, so that a so-called let-off feeling can be obtained in the touch feeling when a player plays the piano.

Thereafter, at timing when the key is released and returned by about ⅓ of the keyboard depth, the repetition lever starts to operate, and returns and rotates in a predetermined direction by the spring force of the repetition spring, so that the shank roller is pushed up while being slid. As a result, the jack rotates in the predetermined direction by the spring force of the repetition spring and returns to the original position, so that next string striking can be performed even if the key does not completely return to the position in the key release state.

On the other hand, in an electronic piano, for example, a keyboard device disclosed in JP 2010-262129 A already filed by the present applicant is known as a keyboard device that rotates a hammer when a key is depressed and provides a let-off feeling similar to that of a grand piano. A keyboard device for an electronic piano includes a key that extends in a front-rear direction and is swingable around a balance pin provided near a center in a length direction, an action chassis that is provided on a rear side of the key, a hammer that is rotatably supported by the action chassis and is placed on a rear end portion of the key, a let-off component that is attached to the action chassis and imparts a let-off feeling to the key at the time of key depression via the hammer, and the like.

In this electronic piano, when the key is depressed, the rear end portion of the key rises, whereby the hammer is pushed up and rotates upward. During the rotation of the hammer, an engagement portion of the hammer temporarily engages with the let-off component. In this case, the hammer engages with the let-off component to compress the let-off component, and as a reaction thereof, the repulsive force from the let-off component acts on the hammer, and the touch weight of the key rapidly increases due to the rotational resistance at that time. When the hammer further rotates to release the engagement with the let-off component, the rotational resistance disappears, so that the touch weight of the key rapidly decreases. Due to the rapid increase and decrease in the touch weight of the key described above, a let-off feeling similar to that of the grand piano is imparted to the touch feeling of the key.

### CITATION LIST

### Patent Literature

Patent Literature 1: JP 2003-167572 A

Patent Literature 2: JP 2010-262129 A

### SUMMARY

However, in the grand piano, the number of components constituting the action and the hammer is large, and a component that rotates (hereinafter, referred to as the “rotation component”) and a component that supports the rotation component (hereinafter, referred to as the “support component”) are connected via a pin. Specifically, in the support component, a portion that supports the rotation component is formed in a bifurcated shape, and the rotation component is rotatably connected to the support component by inserting the pin into a connection hole of both components in a state where the support component is set inside the portion. As described above, in the grand piano, there are many components of the action and the hammer, and moreover, the assembling work thereof at the time of manufacturing is complicated, which takes time and effort. In addition, in the hammer driven through the action, an attachment position of a hammer shank roller and a form thereof (for example, hardness, surface friction, and shape) may vary. Therefore, in order to properly operate the hammer, it is necessary to adjust a rotation range of each component of the action and the hammer, and the adjustment work is complicated.

On the other hand, since the electronic piano has a relatively simple structure in which the hammer is directly pushed upward and rotated by the rear end portion of the depressed key, a load change with respect to the depression amount of the front end portion of the key at the time of key depression and a touch feeling such as a stop feeling when the key is depressed are slightly different from those of the grand piano. Further, in the electronic piano described above, the let-off component is used in order to obtain a let-off feeling due to the disengagement of the jack in the action of the grand piano, but the hammer is not driven by a mechanism such as the action of the grand piano. Therefore, the electronic piano is different from a keyboard of a grand piano in a change in response feeling from a weak strike to a strong strike, and controllability such as a continuous strike, a staccato, and a trill. Therefore, in the electronic piano described above, it is difficult to say that the controllability at the time of high playing performed in the limit range of the performance of the grand piano can be sufficiently reproduced, and there is room for improvement.

The present invention has been made to solve the above-described problems, and it is an object of the present invention to provide a keyboard device for a keyboard instrument that can improve productivity and maintainability by reducing the number of components and reducing the number of adjustment portions as compared with a grand piano, and can obtain a touch feeling and a playing property equivalent to those of the grand piano at the time of playing by obtaining a hammer with high dimensional accuracy.

In order to achieve the above object, the present invention according to claim 1 includes: a key extending in a front-rear direction by a predetermined length and being swingable with a vicinity of a center in a length direction as a fulcrum; an action unit provided in a rear portion of the key and configured to execute a predetermined operation in conjunction with depression of the key; a hammer support disposed on a rear side of the key; and a hammer extending in the front-rear direction by a predetermined length, rotatably supported by a hammer support shaft extending in a left-right direction of the hammer support at a rear end portion, placed on the action unit via a hammer protruding portion provided so as to protrude downward immediately on a front side of the hammer support shaft, and driven upward via the action unit in accordance with depression of the key, wherein the hammer includes a hammer body extending in the front-rear direction by a predetermined length and made of a synthetic resin, and the hammer protruding portion includes a protruding portion body protruding downward and formed integrally with the hammer body, and a protruding portion cover formed of a molded product made of a predetermined material and attached to the hammer body in a state of covering the protruding portion body.

According to this configuration, the action unit is provided at the rear portion of the key, and the hammer, the rear end portion of which is rotatably supported by the hammer support shaft of the hammer support, is placed on the action unit via the hammer protruding portion immediately on the front side of the hammer support shaft. When the front end portion of the key is pushed down at the time of key depression, the rear end portion of the key moves upward, and accordingly, the action unit executes a predetermined operation, so that the hammer is driven upward. This hammer has the hammer body made of the synthetic resin. In addition, the hammer protruding portion placed on the action unit includes the protruding portion body formed integrally with the hammer body, and the protruding portion cover attached to the hammer body in a state of covering the protruding portion body.

In the keyboard device, by providing the action unit at the rear end portion of the key, and reducing the number of components and the number of adjustment portions as compared with an action of a grand piano, productivity and maintainability can be improved. The hammer protruding portion corresponds to a shank roller in a hammer of a grand piano, and the protruding portion body of the hammer protruding portion is formed integrally with the hammer body, and the protruding portion cover made of a molded product is attached in a state of covering the protruding portion body, so that a hammer with high dimensional accuracy can be obtained. In addition, the action unit executes a predetermined operation, for example, an operation similar to that of the action of the grand piano in conjunction with the key depression, so that it is possible to obtain a touch feeling and a playing property equivalent to those of the grand piano at the time of playing.

In addition, since the protruding portion cover made of a molded product is attached to the hammer body in a state of covering the protruding portion body, the form of the portion placed on the action unit in each hammer, for example, hardness, surface friction, shape, and the like can be made uniform. As a result, it is possible to stably obtain a let-off feeling when each key is depressed.

The present invention according to claim 2 is characterized in that, in the keyboard device for the keyboard instrument according to claim 1, the protruding portion cover includes a cover body opening upward and attached to the protruding portion body in a state where the protruding portion body is fitted, and two left and right hooks protruding upward from the cover body and provided at a predetermined interval in the left-right direction, and the hammer body includes two left and right hook receivers provided on both left and right sides immediately above the protruding portion body and engaging the two hooks in a disconnection prevention state when the cover body is attached to the protruding portion body.

According to this configuration, the protruding portion cover has the cover body and the two left and right hooks, and when the cover body is attached to the protruding portion body, the two hooks are engaged with the two left and right hook receivers of the hammer body in the disconnection prevention state. This ensures that the protruding portion cover is securely and stably attached to the hammer body and prevents the protruding portion cover from disengaging from the protruding portion body during operation of the hammer.

The present invention according to claim 3 is characterized in that, in the keyboard device for the keyboard instrument according to claim 2, the cover body has a side surface shape convexly curved downward and is formed in an arc shape having a predetermined curvature.

According to this configuration, since the side surface shape of the cover body is convexly curved downward and is the arc shape having the predetermined curvature, the curvature of the side surface shape is appropriately set, so that an appropriate and stable operation of the hammer can be secured by the predetermined operation of the action unit with the key depression.

### BRIEF DESCRIPTION OF DRAWINGS

FIGS. 1A and 1B illustrate a part of a keyboard device of an electronic piano to which a keyboard device according to an embodiment of the present invention is applied, in which FIG. 1A is a perspective view and FIG. 1B is a right side view;

FIG. 2A is a perspective view illustrating an action unit assembled to a key and a hammer placed on the action unit, and FIG. 2B is an exploded perspective view illustrating the key, the action unit, and the hammer;

FIGS. 3A and 3B are perspective views illustrating a hammer support, in which FIG. 3A is an external view and FIG. 3B is a view illustrating the hammer support in a partially cut state;

FIGS. 4A and 4B are views illustrating the hammer support, in which FIG. 4A is a front view and FIG. 4B is a cross-sectional view taken along the line A-A;

FIGS. 5A and 5B are enlarged perspective views illustrating the hammer and the action unit, in which FIG. 5A illustrates a state where components of the action unit are combined and FIG. 5B illustrates a state where the components of the action unit are disassembled;

FIG. 6A is a right side view illustrating the hammer, and FIG. 6B is an enlarged perspective view illustrating a state before a roller bush is attached to a hammer body;

FIG. 7 is a right side view illustrating a holder;

FIG. 8 is a right side view illustrating a repetition lever;

FIG. 9 is a right side view illustrating a jack;

FIGS. 10A and 10B are explanatory diagrams for sequentially describing the operation of the action unit and the hammer at the time of key depression, in which FIG. 10A illustrates a key release state and FIG. 10B illustrates a state where the repetition lever abuts on a repetition stopper at the time of key depression;

FIGS. 11A and 11B are explanatory diagrams following FIGS. 10A and 10B, in which FIG. 11A illustrates a state where the jack abuts on a jack stopper and FIG. 11B illustrates a state where the jack is removed from a hammer protruding portion;

FIGS. 12A and 12B are explanatory diagrams following FIGS. 11A and 11B, in which FIG. 12A illustrates a state where the hammer abuts on the hammer stopper and FIG. 12B illustrates a state where the hammer rebounds from the hammer stopper and abuts on a backcheck; and

FIGS. 13A and 13B are explanatory diagrams following FIGS. 12A and 12B, in which FIG. 13A illustrates a state where a key pushed down slightly returns and the jack wraps around the lower side of the hammer protruding portion and FIG. 13B illustrates a state where the key returns to an original key release state.

### DETAILED DESCRIPTION

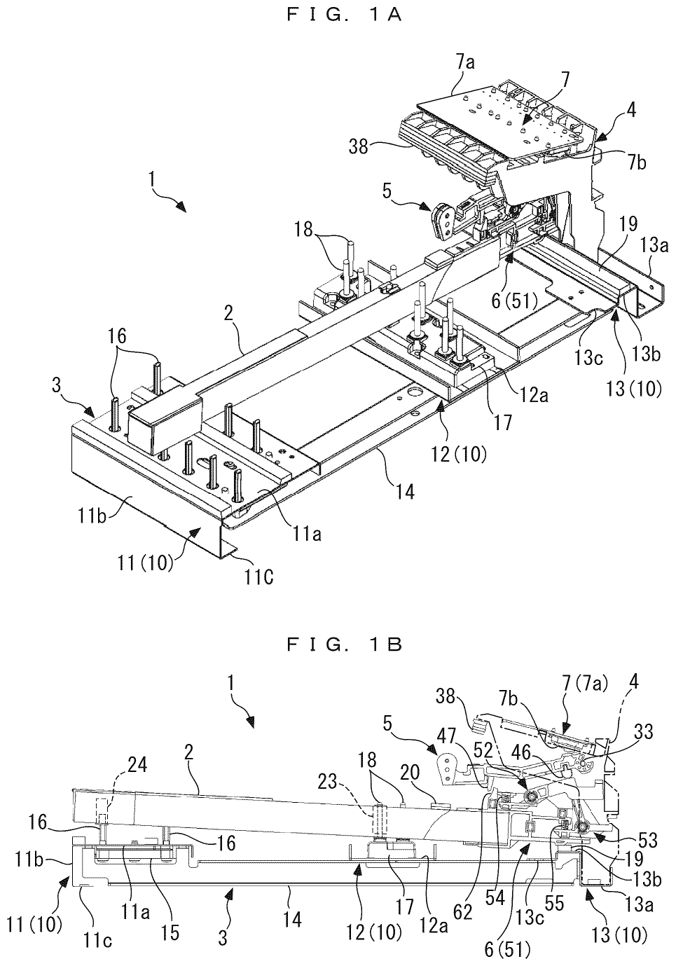

Hereinafter, preferred embodiments of the present invention will be described in detail with reference to the drawings. FIGS. 1A and 1B illustrate a part of a keyboard device of an electronic piano to which a keyboard device according to an embodiment of the present invention is applied in a key release state, in which FIG. 1A is a perspective view and FIG. 1B is a right side view.

As illustrated in FIGS. 1A and 1B, a keyboard device 1 includes a large number of keys 2 (only one white key is illustrated in FIGS. 1A and 1B) arranged in a left-right direction of the electronic piano, a keyboard chassis 3 that supports these keys 2, a hammer support 4 connected to a rear end portion of the keyboard chassis 3, a hammer 5 provided for each key 2 and rotatably supported by the hammer support 4, an action unit 6 provided at the rear end portion of the key 2 and driving the hammer 5 upward along with depression of the key, a key switch 7 for detecting key depression information of the key 2, and the like.

As illustrated in FIGS. 1A and 1B, the keyboard chassis 3 is formed by assembling three support rails 10 extending in the left-right direction and including a front rail 11, a middle rail 12, and a rear rail 13 disposed at a predetermined interval in a front-rear direction (the left-right direction in FIG. 1B), and a plurality of (for example, five) reinforcement ribs 14 (only one is illustrated in FIGS. 1A and 1B) extending in the front-rear direction and disposed at a predetermined interval in the left-right direction, in a form of parallel crosses. The support rail 10 and the rib 14 are formed of an iron plate formed in a predetermined shape by, for example, press punching and bending, and are connected to each other by screwing.

The front rail 11 includes a horizontal top plate portion 11a, a front plate portion 11b bent downward at a right angle from a front end portion of the top plate portion 11a, and a bottom plate portion 11c bent backward at a right angle from a lower end portion of the front plate portion 11b. A reed front 15 is fixed to a bottom surface of the top plate portion 11a by screwing or the like. The reed front 15 is formed in a thick plate shape made of a synthetic resin and extends in the left-right direction over the entire front rail 11. On the reed front 15, a large number of front pins 16 are erected at front and rear positions corresponding to the white key 2 and the black key (not illustrated) in a state of penetrating the top plate portion 11a of the front rail 11 and being arranged in the left-right direction.

The middle rail 12 has a horizontal reed middle placement portion 12a, and a front end portion and a rear end portion thereof are bent upward at a right angle. The reed middle 17 is fixed to the reed middle placement portion 12a by screwing or the like in a state where the reed middle is placed. The reed middle 17 is formed in a thick plate shape made of a synthetic resin and extends in the left-right direction over the entire middle rail 12. In the reed middle 17, a large number of balance pins 18 are erected in a state of being arranged in the left-right direction at front and rear positions corresponding to the white key 2 and the black key.

The rear rail 13 has an accommodation recess portion 13a that is opened upward and engages with a lower portion of the hammer support 4 in an accommodated state, a cushion placement portion 13b that is bent at a right angle from an upper end portion of a front plate portion of the accommodation recess portion 13a and horizontally extends forward, and is attached with a cushion 19 extending in the left-right direction in a placed state, and a connection portion 13c that is one step downward from a front end portion of the cushion placement portion 13b and horizontally extends forward. A plurality of attachment holes penetrating the accommodation recess portion 13a in the front-rear direction are formed in the front plate portion of the accommodation recess portion 13a, and the lower end portion of the hammer support 4 is screwed to the rear rail 13 through these attachment holes. The accommodation recess portion 13a and the connection portion 13c are screwed to the rear end portion of each rib 14.

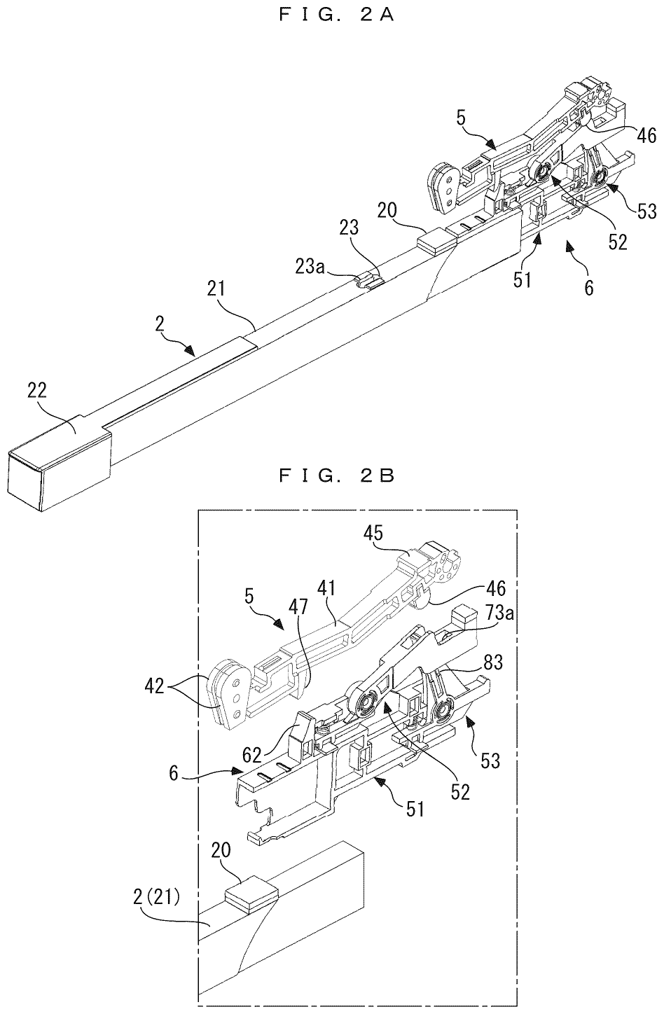

FIG. 2A illustrates the action unit 6 assembled to the key 2 and the hammer 5 placed on the action unit 6, and FIG. 2B illustrates the key 2, the action unit 6, and the hammer 5 in an exploded manner. As illustrated in FIG. 2A, the key 2 includes a wooden key body 21 extending by a predetermined length in the front-rear direction and having a rectangular cross section, and a synthetic resin key cover 22 bonded to a top surface and a front surface of a front half portion of the key body 21. A balance pin hole 23 penetrating the key body 21 in the up-down direction is formed near the center in the length direction of the key body 21, and the key 2 is swingably supported by the balance pin 18 erected on the reed middle 17 through the balance pin hole 23.

The balance pin hole 23 is provided with a substantially circular hole in the vicinity of the bottom surface of the key body 21, and the entire upper portion connected to the hole is formed in an elongated shape extending in the length direction of the key body 21. In addition, a felt 23a is provided on left and right inner surfaces of the balance pin hole 23 in order to smoothly slide with respect to the balance pin 18 when the key 2 swings. A cushion 20 is bonded to the top surface of the key body 21 on the rear side of the balance pin hole 23, and the cushion 20 prevents the front end portion of the hammer 5 from directly hitting the key 2 during maintenance or the like.

In addition, a front pin hole 24 (see FIG. 1B) opened downward is formed at a predetermined position of the front portion of the key body 21, and the front pin hole 24 is engaged with the front pin 16 erected on the reed front 15, thereby preventing the key 2 from shaking in the left-right direction when the key 2 swings.

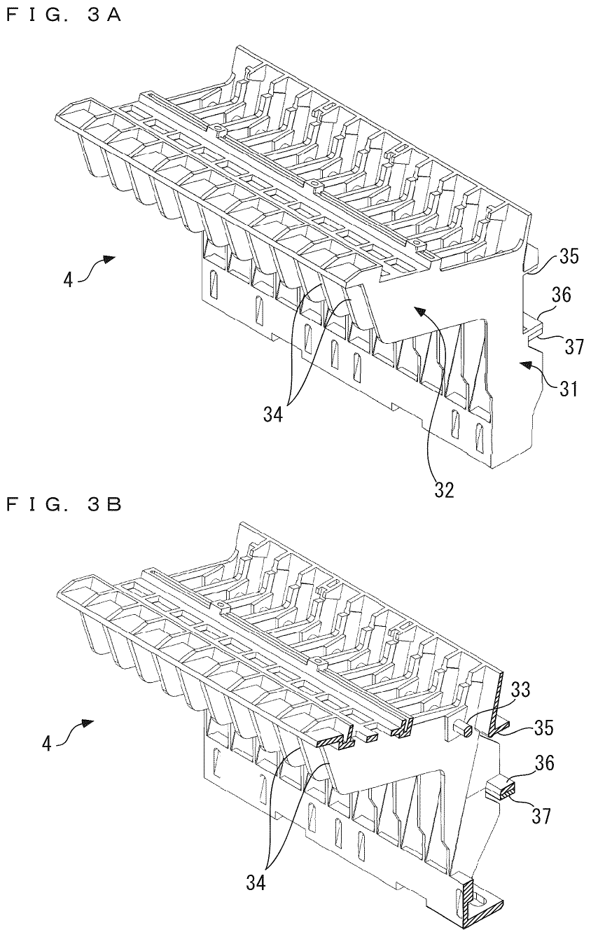

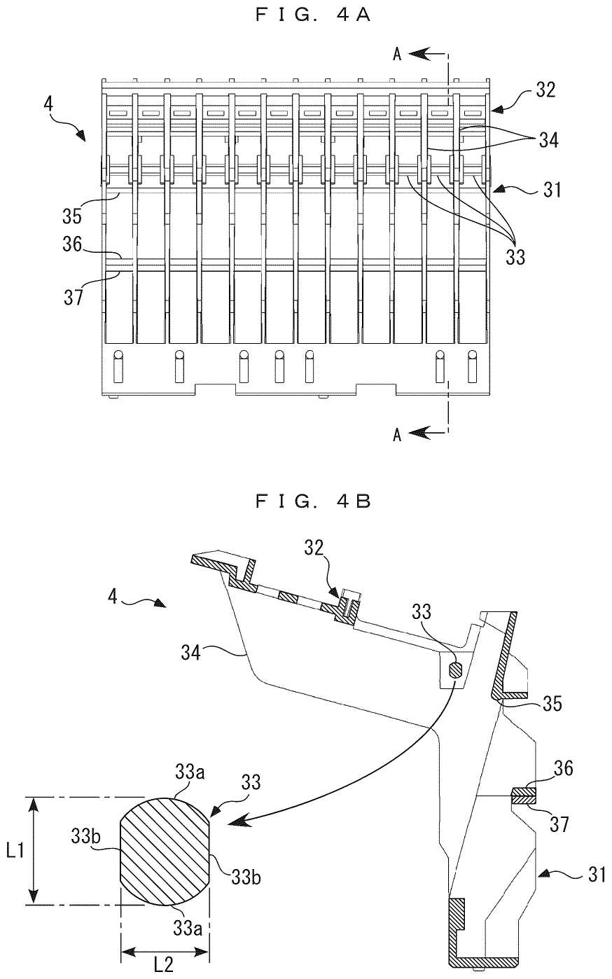

FIGS. 3A to 4B illustrate the hammer support 4. As illustrated in FIGS. 3A to 4B, the hammer support 4 is formed of a molded product made of a synthetic resin, and is screwed to the rear rail 13 of the keyboard chassis 3 in a state where a plurality of molded products corresponding to one octave are connected to each other in the left-right direction, for example. The hammer support 4 includes a hammer support portion 31 standing upright from the vicinity of the rear rail 13, a switch attachment portion 32 extending obliquely upward forward from an upper end portion thereof, and the like. A hammer support shaft 33 for rotatably supporting each hammer 5 is provided at the upper end portion of the hammer support portion 31.

The hammer support 4 has a plurality of partition walls 34 that partition the adjacent hammers 5 at predetermined intervals in the left-right direction, and the hammer support shaft 33 extends in the left-right direction between the adjacent partition walls 34 and 34. As illustrated in an enlarged manner in FIG. 4B, the hammer support shaft 33 has a so-called oval cross-sectional shape in which front and rear two portions of a circle centered on the axial center of the hammer support shaft 33 are cut out.

Specifically, an outer peripheral surface of the hammer support shaft 33 includes a pair of upper and lower curved surface portions 33a and 33a and a pair of front and rear flat surface portions 33b and 33b extending between the curved surface portions 33a and 33a. In the hammer support shaft 33 configured as described above, the upper and lower curved surface portions 33a and 33a are set in an arc shape having a diameter of a length L1, while a distance between the front and rear flat surface portions 33b and 33b is set to a length L2 shorter than the length L1.

As illustrated in FIGS. 1A and 1B, the key switch 7 is attached to the switch attachment portion 32 of the hammer support 4. The key switch 7 includes a switch substrate 7a formed of a printed circuit board, and a switch body 7b formed of a rubber switch attached to the hammer 5 side of the switch substrate 7a for each key 2.

As illustrated in FIGS. 3A to 4B, on the back surface side of the hammer support 4, a repetition stopper 35 is provided obliquely below and behind the hammer support shaft 33, a repetition lever 52 (described later) of the action unit 6 abuts on the hammer support 4 at the time of key depression, and the repetition stopper 35 locks the repetition lever 52. Furthermore, on the back surface side of the hammer support 4, a jack stopper 36 is provided below the repetition stopper 35, a jack 53 (described later) of the action unit 6 abuts on the hammer support 4 at the time of key depression, and the jack stopper 36 locks the jack 53. A cushion 37 extending in the left-right direction is attached to a bottom surface of the jack stopper 36.

As illustrated in FIGS. 1A and 1B, a hammer stopper 38 is provided at an upper portion of the front end of the hammer support 4, when the hammer 5 rotates upward, the hammer 5 abuts on the hammer support 4 from below, and the hammer stopper 38 prevents further rotation.

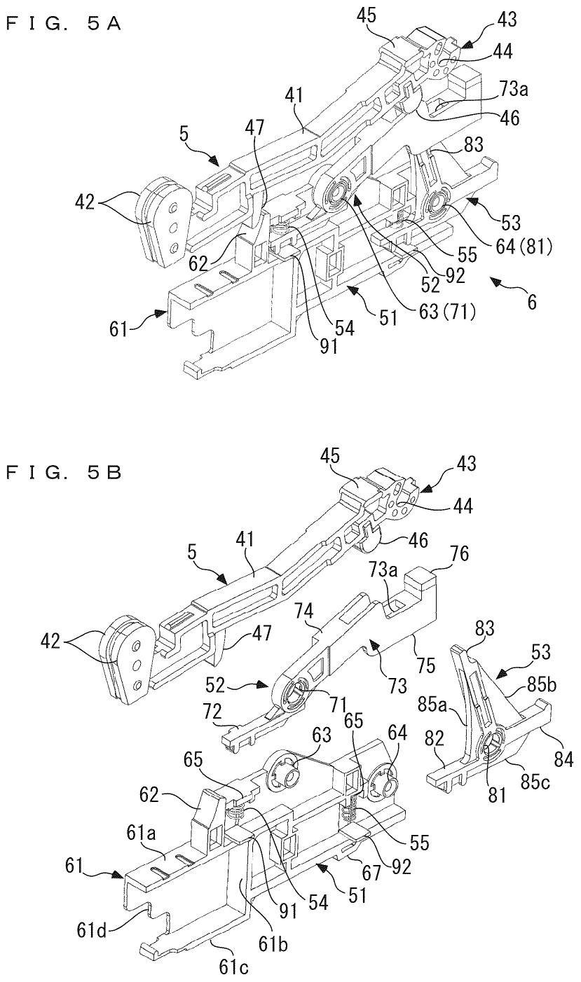

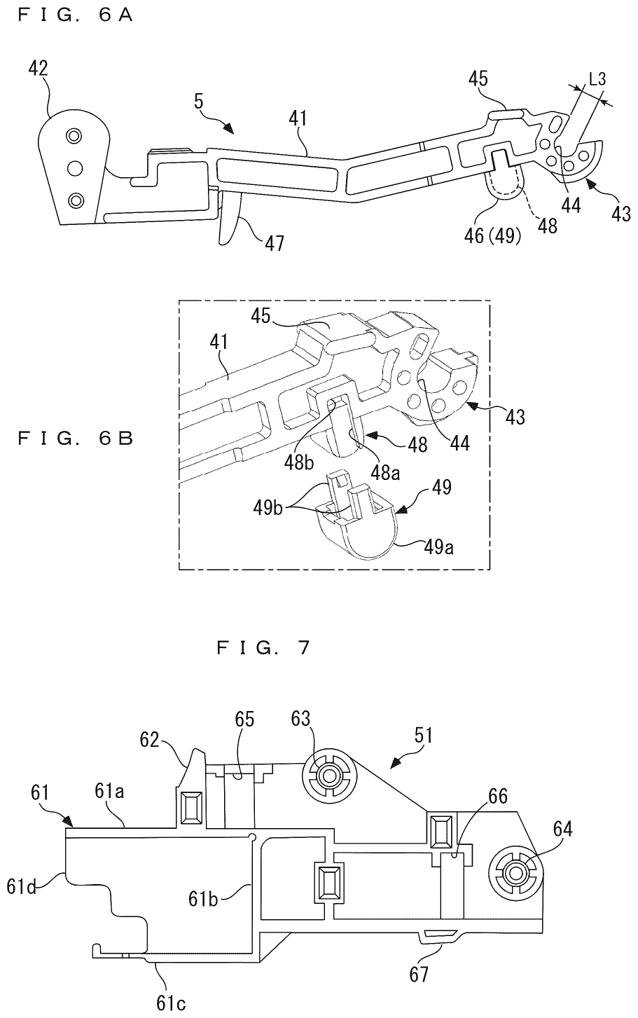

FIGS. 5A and 5B illustrate the hammer 5 and the action unit 6, in which FIG. 5A illustrates a state where each component of the action unit is combined, and FIG. 5B illustrates a state where each component of the action unit is disassembled. FIG. 6A is a right side view illustrating the hammer 5. As illustrated in these drawings, the hammer 5 includes an arm-shaped hammer body 41 extending in the front-rear direction by a predetermined length, and two weight plates 42 and 42 attached to front end portions of left and right side surfaces of the hammer body. The hammer body 41 is made of a synthetic resin, and the weight plate 42 is made of a metal material such as iron having a relatively large specific gravity.

At the rear end portion of the hammer body 41, an engagement portion 43 that engages with the hammer support shaft 33 of the hammer support 4 is provided. An arc-shaped shaft hole 44 penetrating the engagement portion 43 in the left-right direction and having a side surface shape formed in a C shape is formed in the engagement portion 43, and an opening thereof is formed to expand outward. The shaft hole 44 has a diameter slightly larger than a diameter (length L1) of the upper and lower curved surface portions 33a and 33a of the hammer support shaft 33, and a width L3 of the opening is slightly larger than the length L2 between the front and rear flat surface portions 33b and 33b of the hammer support shaft 33 and smaller than the length L1. The hammer 5 is attached to or detachable from the hammer support shaft 33 of the hammer support 4 through the opening of the shaft hole 44, and is rotatably supported by the hammer support 4 by fitting the shaft hole 44 to the hammer support shaft 33.

In the rear portion of the hammer 5, a switch pressing portion 45 and a hammer protruding portion 46 are provided above and below the right front side of the shaft hole 44, respectively. The switch pressing portion 45 has a flat top surface, and presses the switch body 7b of the key switch 7 when the hammer 5 rotates upward, thereby detecting key depression information of the key 2 corresponding to the hammer 5.

On the other hand, the hammer protruding portion 46 corresponds to a shank roller of a hammer of a grand piano. FIG. 6B is an enlarged view of a state before the roller bush 49 (protruding portion cover) is attached to the hammer body 41. As illustrated in FIG. 6B, the hammer protruding portion 46 is formed integrally with the hammer body 41, and has a protruding portion body 48 protruding downward and a roller bush 49 attached to the hammer body 41 in a state of covering the protruding portion body 48.

The protruding portion body 48 protrudes downward, and a side surface shape of a distal end portion is formed in an arc shape. The protruding portion body 48 is formed symmetrically, and each side surface (FIG. 6B illustrates a right side surface) is provided with a groove portion 48a extending in the up-down direction and opening outward, and a locking recess portion 48b (hook receiver) provided at an upper end portion of the groove portion 48a.

On the other hand, the roller bush 49 is made of a predetermined elastic material (for example, thermoplastic elastomer), and is formed of a molded product having a predetermined shape. Specifically, as illustrated in FIG. 6B, the roller bush 49 has a bush body 49a (cover body) that opens upward, is formed so that the protruding portion body 48 of the hammer body 41 can be fitted, and is attached to the protruding portion body 48, and two left and right hooks 49b and 49b that protrudes upward from the bush body 49a and are provided at predetermined intervals in the left-right direction. The bush body 49a is formed such that a side surface shape is convexly curved downward and has a predetermined curvature, for example, substantially the same curvature as a shank roller of a grand piano. Each hook 49b is formed in a claw shape in which an upper end portion thereof protrudes inward.

In the hammer protruding portion 46 configured as described above, the protruding portion body 48 of the hammer body 41 is fitted into the bush body 49a of the roller bush 49, and the roller bush 49 is attached to the hammer body 41 in a state where both the hooks 49b and 49b of the roller bush 49 are fitted into the corresponding left and right groove portion 48a and locking recess portion 48b of the protruding portion body 48. In this case, the upper end portion of each hook 49b of the roller bush 49 is locked in the locking recess portion 48b of the protruding portion body 48 in a disconnection prevention state.

In the key release state, the hammer protruding portion 46 is placed on a hammer placement portion 74 of the repetition lever 52 (described later) of the action unit 6.

As illustrated in FIGS. 5A and 5B and 6A, at a predetermined position on the front portion of the hammer 5, a backcheck engagement portion 47 which is formed integrally with the hammer body 41, protrudes downward, and can be engaged with a backcheck 62 (described later) of the action unit 6 is provided. As illustrated in FIG. 6A, the backcheck engagement portion 47 has a vertically long side surface, a flat front surface, and a gently curved back surface.

Next, the action unit 6 will be described. As illustrated in FIGS. 5A and 5B, the action unit 6 includes a holder 51 fixed to a rear end portion of the key 2, a repetition lever 52 and a jack 53 rotatably attached to the holder, and a repetition spring 54 and a jack spring 55 that bias them to rotate in a predetermined direction, both of which are coil springs.

FIG. 7 illustrates a right side view of the holder 51. As illustrated in FIG. 5A and 5B and 7, the holder 51 is made of a synthetic resin, and is formed of a molded product having a predetermined shape and extending in the front-rear direction. The holder 51 includes a key attachment portion 61 provided at the front portion and fixed to the rear end portion of the key 2, a backcheck 62 provided above the key attachment portion, a repetition support shaft 63 provided at the upper end portion near the center in the front-rear direction and rotatably supporting the repetition lever 52, and a jack support shaft 64 provided at the rear end portion and rotatably supporting the jack 53.

The key attachment portion 61 has a side surface formed in a U shape by an upper wall 61a, a rear wall 61b, and a lower wall 61c, and left end portions thereof are connected by a left side wall 61d. Therefore, when the holder 51 is attached to the rear end portion of the key 2, the upper wall 61a, the rear wall 61b, the lower wall 61c, and the left side wall 61d are firmly fixed by adhesion in a state of being in contact with a top surface, a rear surface, a bottom surface, and a left side surface at the rear end portion of the key 2.

The backcheck 62 has a predetermined length in the up-down direction and is formed in a gentle arc shape in a state of facing obliquely upward forward. The backcheck 62 is configured to lock the backcheck engagement portion 47 of the hammer 5 while slidingly contacting the backcheck engagement portion 47 when the backcheck engagement portion 47 is engaged. A friction member such as synthetic leather may be attached to at least one of the surfaces of the backcheck 62 and the backcheck engagement portion 47 in sliding contact with each other in order to increase friction.

Both the repetition support shaft 63 and the jack support shaft 64 are formed in a cylindrical shape protruding rightward by a predetermined length and having a predetermined diameter. The repetition support shaft 63 is formed at a predetermined position higher than the jack support shaft 64.

The holder 51 is provided with a repetition spring locking portion 65 that locks an upper end portion of the repetition spring 54 at a predetermined position in front of the repetition support shaft 63 between the backcheck 62 and the repetition support shaft 63. Further, the holder 51 is provided with a jack spring locking portion 66 that locks the upper end portion of the jack spring 55 at a predetermined position in front of the jack support shaft 64 between the repetition support shaft 63 and the jack support shaft 64. In addition, a convex portion 67 slightly protruding downward is provided in the rear portion of the bottom surface of the holder 51, and the holder 51 is placed on the cushion 19 on the rear rail 13 via the convex portion 67 in the key release state.

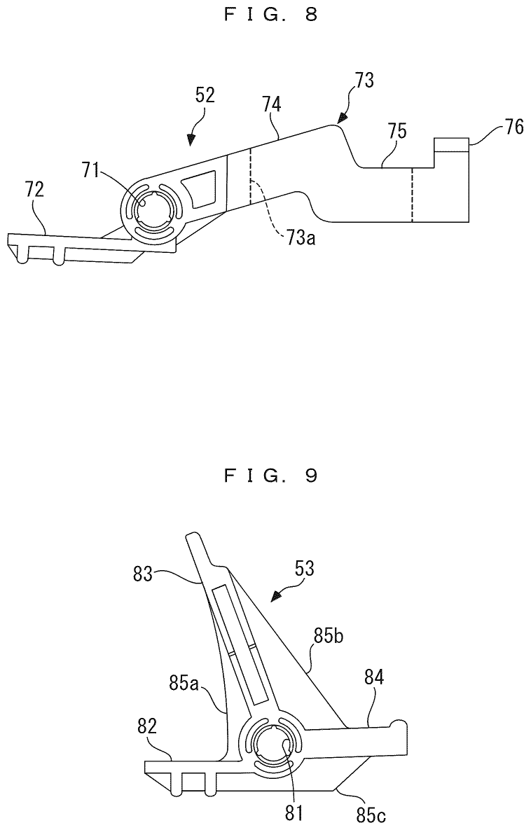

FIG. 8 illustrates a right side view of the repetition lever 52. As illustrated in FIGS. 5A and 5B and 8, the repetition lever 52 is made of a synthetic resin, and is formed of a molded product having a predetermined shape and formed to extend in the front-rear direction. The repetition lever 52 includes a fitting hole 71 penetrating the repetition lever 52 in the left-right direction and rotatably fitted to the repetition support shaft 63 of the holder 51, a front arm 72 extending forward from the vicinity of the fitting hole 71, and a hammer placement arm 73 formed to extend backward from the vicinity of the fitting hole 71, on which the hammer 5 is placed, and with which the jack 53 is engaged.

The hammer placement arm 73 of the repetition lever 52 includes a hammer placement portion 74 having a side surface shape extending by a predetermined length obliquely rearward and upward from the fitting hole 71, and an extension portion 75 extending obliquely rearward and downward from a rear end portion of the hammer placement portion 74 and further extending rearward. In addition, a jack guide hole 73a penetrating the hammer placement arm 73 in the up-down direction and extending in the front-rear direction across the hammer placement portion 74 and the extension portion 75 is formed in the hammer placement arm 73. A rear end portion of the extension portion 75 is formed so as to slightly protrude upward, and the cushion 76 is attached to a top surface thereof.

FIG. 9 illustrates a right side view of the jack 53. As illustrated in FIGS. 5A and 5B and 9, the jack 53 is made of a synthetic resin and is formed of a molded product having a predetermined shape. The jack 53 includes a fitting hole 81 penetrating the jack 53 in the left-right direction and rotatably fitted to the jack support shaft 64 of the holder 51, a front arm 82 extending forward from the vicinity of the fitting hole 81, a hammer push-up portion 83 extending upward by a predetermined length from the vicinity of the fitting hole 81, and a rear arm 84 extending rearward from the vicinity of the fitting hole 81.

The hammer push-up portion 83 extends obliquely upward and forward in a state of being inclined forward by a predetermined angle with respect to the front arm 82 and the rear arm 84 extending substantially horizontally in the front-rear direction. In addition, the upper end portion of the hammer push-up portion 83 is formed to have a smaller width in the front-rear direction than the lower portion thereof. In addition, the rear arm 84 is formed such that a rear end portion slightly protrudes upward.

In the jack 53, plate-shaped reinforcement ribs 85a, 85b, and 85c are provided between the front arm 82 and the hammer push-up portion 83, between the hammer push-up portion 83 and the rear arm 84, and between the rear arm 84 and the front arm 82, respectively. The strength of the jack 53 is increased by the reinforcement ribs 85a to 85c and the like.

In the action unit 6 formed as described above, as illustrated in FIG. 5A, the hammer push-up portion 83 of the jack 53 is engaged in a state of being inserted into the jack guide hole 73a of the repetition lever 52 from below. As illustrated in FIG. 5A, the front arm 72 of the repetition lever 52 is biased downward by the repetition spring 54, while the front arm 82 of the jack 53 is biased downward by the jack spring 55. As a result, the repetition lever 52 and the jack 53 are biased in the counterclockwise direction in FIG. 5A around the repetition support shaft 63 and the jack support shaft 64, respectively. In the holder 51 of the action unit 6, thin-plate cushions 91 and 92 are attached to the lower side of the front arm 72 of the repetition lever 52 and the lower side of the front arm 82 of the jack 53.

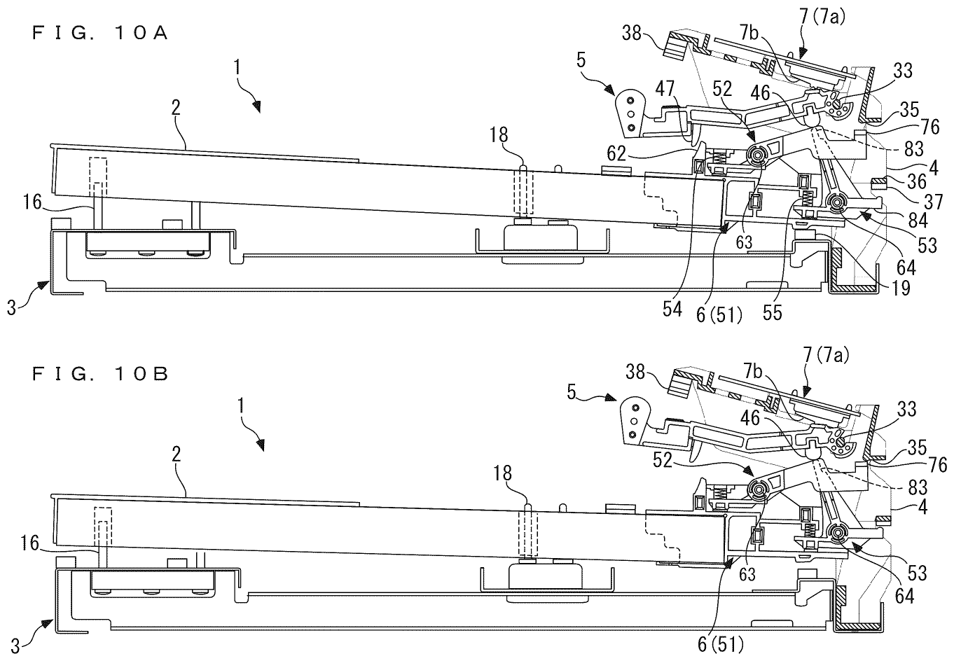

Next, operations of the action unit 6 and the hammer 5 when the key 2 is depressed will be described with reference to FIGS. 10A to 13B.

FIG. 10A illustrates the keyboard device 1 in the key release state. In the key release state, the hammer 5 is placed on the hammer placement portion 74 of the repetition lever 52 via the hammer protruding portion 46, and the upper end portion of the hammer push-up portion 83 of the jack 53 faces the hammer protruding portion 46 with a gap. In the key release state, a gap is provided between the backcheck engagement portion 47 of the hammer 5 and the backcheck 62 of the holder 51.

When the front end portion of the key 2 is pushed down from the key release state, the key 2 swings forward and downward about the balance pin 18, and the rear end portion of the key 2 moves upward. Accordingly, the action unit 6 also moves upward integrally with the rear end portion of the key 2, and the hammer 5 is pushed up by the repetition lever 52 via the hammer protruding portion 46. As a result, the hammer 5 rotates upward (clockwise in FIGS. 10A and 10B) around the hammer support shaft 33.

Next, when the key depression progresses and the action unit 6 moves upward, the rear end portion of the repetition lever 52 abuts on the repetition stopper 35 of the hammer support 4 from below via the cushion 76 as illustrated in FIG. 10B. As a result, while the rear end portion of the repetition lever 52 is locked, the upper end portion of the hammer push-up portion 83 of the jack 53 abuts on the hammer protruding portion 46 from below. As a result, the hammer 5 is pushed up by the hammer push-up portion 83 of the jack 53 and further rotates upward.

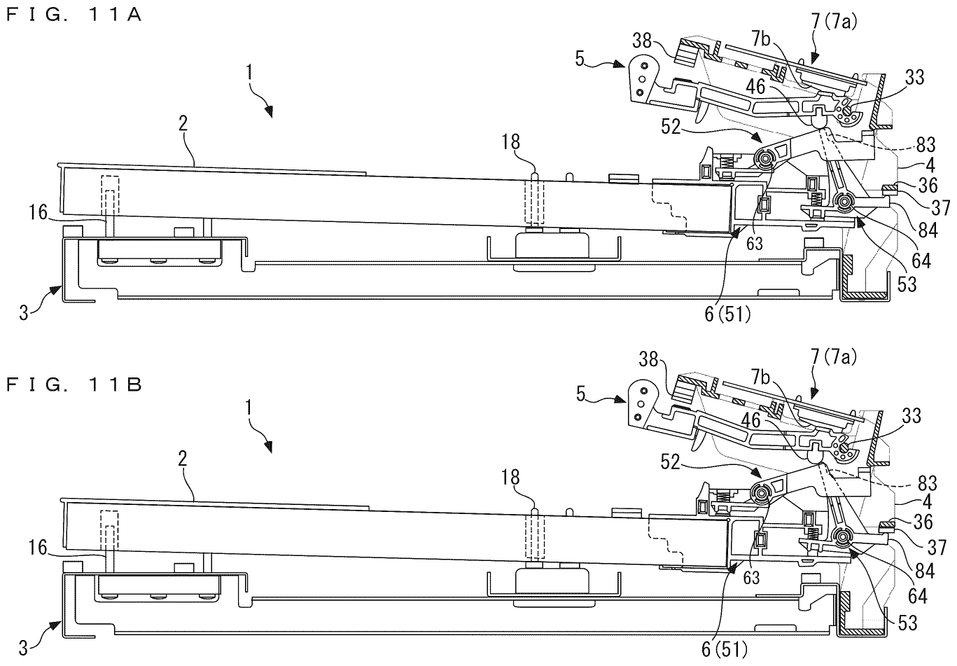

Next, when the key depression further proceeds and the action unit 6 further moves upward, the rear end portion of the rear arm 84 of the jack 53 abuts on the jack stopper 36 (cushion 37) from below as illustrated in FIG. 11A. As a result, the jack support shaft 64 moves upward in a state where the rear end portion of the rear arm 84 is locked, so that the jack 53 rotates in the clockwise direction of FIG. 11A around the jack support shaft 64. As a result, as illustrated in FIG. 11B, the upper end portion of the hammer push-up portion 83 of the jack 53 moves backward and comes out of the hammer protruding portion 46 of the hammer 5. By such disengagement of the jack 53, the hammer 5 is uncoupled from the action unit 6 and the key 2, and further rotates upward in a freely rotating state.

Note that, when the jack 53 is disengaged, a click feeling is generated due to a rapid increase or decrease in the touch weight of the key 2, whereby a let-off feeling is obtained in the touch feeling of the player who depresses the key.

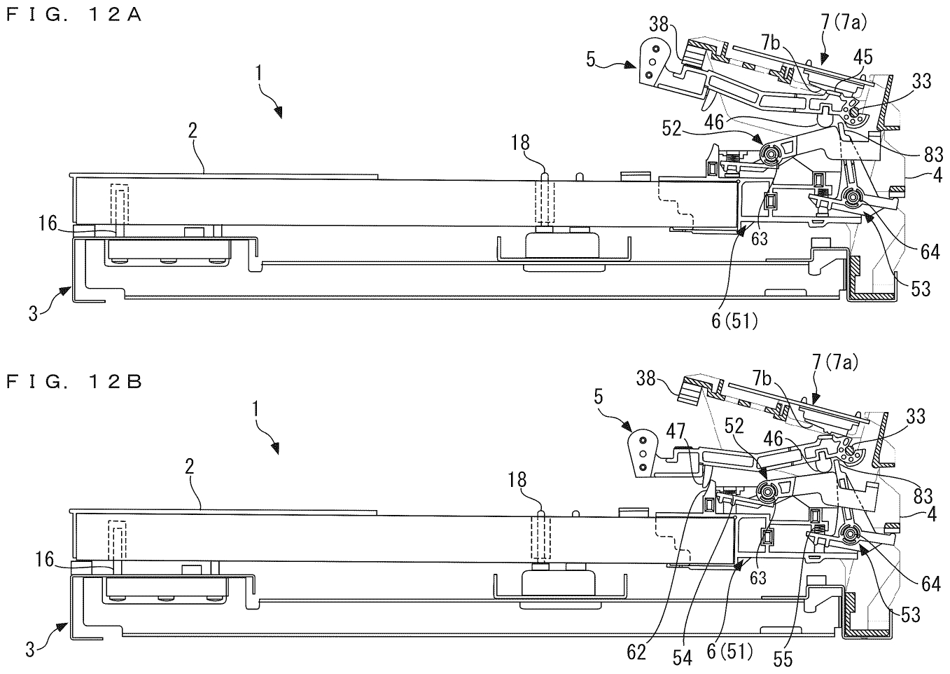

FIG. 12A illustrates a state where the hammer 5 rotated upward abuts on the hammer stopper 38 at the upper portion of the front end of the hammer support 4. In this case, the front portion of the hammer body 41 of the hammer 5 abuts on the hammer stopper 38 from below, so that further rotation of the hammer 5 is prevented. In this case, the switch pressing portion 45 of the hammer 5 presses the switch body 7b of the key switch 7 from below to turn on the key switch 7, whereby the key depression information of the key 2 corresponding to the rotation speed of the hammer 5 or the like is detected and output to a sound generation control device (not illustrated). In addition, the sound generation control device outputs a piano sound from a speaker (not illustrated) of the electronic piano based on the key depression information.

FIG. 12B illustrates a state immediately after the hammer 5 abuts on the hammer stopper 38, specifically, a state where the hammer 5 rebounds from the hammer stopper 38 and rotates downward (counterclockwise) toward the original position before the key depression, and the backcheck engagement portion 47 of the hammer 5 is locked to the backcheck 62 of the holder 51. In this case, when the backcheck engagement portion 47 is locked while being in sliding contact with the backcheck 62, the hammer 5 stops by being prevented from further rotating downward, and occurrence of the rebound and vibration of the hammer 5 is prevented. In this case, the load due to the above rebound of the hammer 5 is transmitted to the key 2. As a result, the player can clearly feel the stop feeling of the key 2 when the key 2 is depressed.

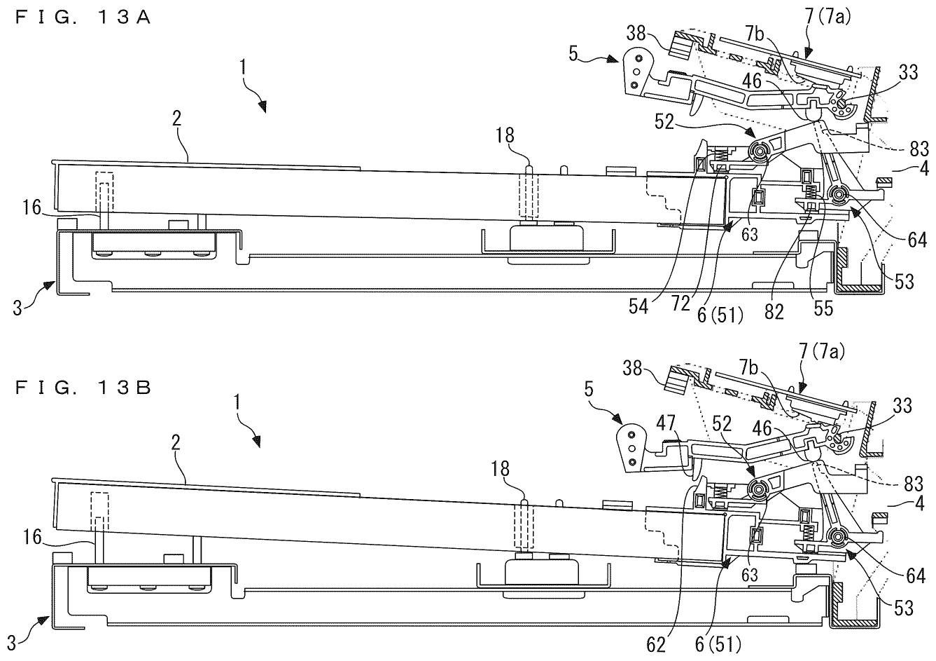

FIG. 13A illustrates a state where the depressed key 2 is slightly (for example, ⅓ of the keyboard depth) returned by the release of the key. When the key 2 is released from the state illustrated in FIG. 12B described above, as illustrated in FIG. 13A, the front end portion of the key 2 moves upward while the rear end portion thereof moves downward, and accordingly, the action unit 6 moves downward integrally with the rear end portion of the key 2. In this case, the backcheck 62 moves obliquely rearward and downward, so that the hammer 5 is released from engagement by the backcheck 62 and is released from the stopped state. In addition, the front arm 72 of the repetition lever 52 is pushed down by the biasing force of the repetition spring 54, so that the repetition lever rotates counterclockwise in FIG. 13A around the repetition support shaft 63. Similarly, the front arm 82 of the jack 53 is pushed down by the biasing force of the jack spring 55, so that the jack rotates in the counterclockwise direction in FIG. 13A around the jack support shaft 64. As a result, as illustrated in FIG. 13A, the upper end portion of the hammer push-up portion 83 of the jack 53 wraps around the lower side of the hammer protruding portion 46 of the hammer 5, and as a result, the hammer 5 can be driven by the action unit 6 even if the key 2 does not completely return to the position in the key release state.

When the key 2 is completely released, as illustrated in FIG. 13B, the key 2, the hammer 5, and the repetition lever 52 and the jack 53 of the action unit 6 return to the original positions of the key release state.

As described above in detail, according to the present embodiment, the keyboard device 1 including the key 2, the action unit 6, and the hammer 5 described above can realize an operation similar to that of a grand piano, so that a touch feeling and a playing property equivalent to those of the grand piano can be obtained at the time of playing. In addition, in the action unit 6 of the keyboard device 1, since the number of components can be reduced and the number of adjustment portions can be reduced as compared with the action of the grand piano, productivity and maintainability of the keyboard device 1 can be improved.

In addition, in the keyboard device 1, the hammer protruding portion 46 of the hammer 5 corresponds to a shank roller in a hammer of a grand piano, the protruding portion body 48 of the hammer protruding portion 46 is formed integrally with the hammer body 41, and the roller bush 49 formed of a molded product is attached in a state of covering the protruding portion body 48, so that the hammer 5 with high dimensional accuracy can be obtained. In addition, since the action unit 6 executes an operation similar to that of the action of the grand piano in conjunction with the key depression, it is possible to obtain a touch feeling and a playing property equivalent to those of the grand piano at the time of playing.

Furthermore, since the roller bush 49 made of a molded product is attached to the hammer body 41 in a state of covering the protruding portion body 48, in each hammer 5 of the keyboard device 1, the form of the portion placed on the action unit 6, for example, the hardness, the surface friction, the shape, and the like can be made uniform. As a result, it is possible to stably obtain a let-off feeling when each key 2 is depressed.

Note that the present invention is not limited to the above-described embodiments, and can be implemented in various modes. For example, in the embodiment, the case where the present invention is applied to a keyboard device of an electronic piano has been described, but the present invention is not limited thereto, and can also be applied to a keyboard device in which, instead of the key switch 7, a string similar to that of the grand piano is stretched above the hammer 5, and the string is struck with the hammer 5.

The detailed configurations of the keyboard device 1, the key 2, the hammer 5, and the action unit 6 described in the embodiment are merely examples, and can be appropriately changed within the scope of the gist of the present invention.

1 what is claimed is:

1. A keyboard device for a keyboard instrument, comprising:
a key extending in a front-rear direction by a predetermined length and being swingable with a vicinity of a center in a length direction as a fulcrum;
an action unit provided in a rear portion of the key and configured to execute a predetermined operation in conjunction with depression of the key;
a hammer support disposed on a rear side of the key; and
a hammer extending in the front-rear direction by a predetermined length, rotatably supported by a hammer support shaft extending in a left-right direction of the hammer support at a rear end portion, placed on the action unit via a hammer protruding portion provided so as to protrude downward immediately on a front side of the hammer support shaft, and driven upward via the action unit in accordance with depression of the key, wherein
the hammer includes a hammer body extending in the front-rear direction by a predetermined length and made of a synthetic resin, and
the hammer protruding portion includes
a protruding portion body protruding downward and formed integrally with the hammer body, and
a protruding portion cover formed of a molded product made of a predetermined material and attached to the hammer body in a state of covering the protruding portion body.

2. The keyboard device for the keyboard instrument according to claim 1, wherein
the protruding portion cover includes
a cover body opening upward and attached to the protruding portion body in a state where the protruding portion body is fitted, and
two left and right hooks protruding upward from the cover body and provided at a predetermined interval in the left-right direction, and
the hammer body includes two left and right hook receivers provided on both left and right sides immediately above the protruding portion body and engaging the two hooks in a disconnection prevention state when the cover body is attached to the protruding portion body.

3. The keyboard device for the keyboard instrument according to claim 2, wherein the cover body has a side surface shape convexly curved downward and is formed in an arc shape having a predetermined curvature.
